(19) United States
(12) Patent Application Publication
(10) Pub. No.: US 2013/0161136 A1
(43) Pub. Date: Jun. 27, 2013

(54) PROCESS FOR COATING A BRAKE DISK AND BRAKE DISK PRODUCED BY THE PROCESS

(71) Applicant: Robert Bosch GmbH, Stuttgart (DE)

(72) Inventors: Wolfgang Huschenhoefer, Asslar (DE); Georg Ketteler, Dautphetal (DE); Rolf Keller, Rutesheim (DE); Juergen Hackenberg, Sachsenheim (DE); Roland Raab, Wiesloch (DE); Olivier Bugada, Ostfildern-Kemnat (DE); Vincent Dupuis, Stuttgart (DE); Hagen Kuckert, Bietigheim-Bissingen (DE); Andreas Mayer, Karlsruhe (DE)

(73) Assignee: Robert Bosch GmbH, Stuttgart (DE)

(21) Appl. No.: 13/712,473

(22) Filed: Dec. 12, 2012

(30) Foreign Application Priority Data
Dec. 27, 2011 (DE) 10 2011 089 923.5

(51) Int. Cl. B05D 7/14

(52) U.S. Cl. CPC B05D 7/14
USPC 188/218 XL; 427/402; 427/405; 205/122

(57) ABSTRACT

A gray cast iron brake disk for a motor vehicle has a wear-reducing surface coating applied thermally, for example, by flame spraying. The brake disk also includes an intermediate layer of, for example, nickel. Due to its resilience, the intermediate layer reduces mechanical stress between the surface coating and the brake disk.

This application claims priority under 35 U.S.C. §119 to patent application no. DE 10 2011 089 923.5, filed on Dec. 27, 2011 in Germany, the disclosure of which is incorporated herein by reference in its entirety.

### BACKGROUND

The disclosure relates to a process for coating a friction surface of a metal brake disk for a disk brake of a surface vehicle, in particular of a motor vehicle, having the features described below, and also to a brake disk which is produced by the process according to the disclosure and has the features described below.

Brake disks made of metal, in particular of steel or of gray cast iron, for disk brakes of motor vehicles are known. To reduce wear, thermal surface coatings comprising chromium carbides and/or tungsten carbides, for example, are known. It is possible for the entire brake disk to be coated on the surface, but it is sufficient to coat friction surfaces of a brake disk, i.e. the surfaces of a brake disk which are in the form of perforated circular disks and against which the friction brake linings are pressed during and for braking. The wear-reducing surface coatings are applied thermally to the brake disk, at least to the friction surfaces of the brake disk, for example by flame spraying or arc spraying at temperatures of between, for example, approximately 3000 and 4000 degrees Celsius.

On account of different coefficients of thermal expansion, the coefficient of thermal expansion of typical wear-reducing surface coatings of brake disks is smaller than the coefficient of thermal expansion of a brake disk made of gray cast iron, mechanical stresses form between the surface coating and the brake disk after cooling following the thermal coating, and when the brake disk heats up during braking to temperatures of several 100 degrees Celsius, for example to up to approximately 600 degrees Celsius. The mechanical stresses between the surface coating and the brake disk can lead to damage to the surface coating, for example as a result of cracking, which, as a result of penetrating salt water in winter, for example, can lead to infiltration of corrosion in the surface coating and to detachment of the surface coating (delamination).

### SUMMARY

The process according to the disclosure having the features described below provides an intermediate layer which is applied cold to the brake disk before the application of the friction-reducing surface coating. The intermediate layer may be applied to the entire brake disk, but it is sufficient to apply it to the friction surfaces of the brake disk or to those regions to which the surface coating is then applied. The intermediate layer is located between the brake disk and the surface coating; it can be construed as a carrier layer for the surface coating.

Since the intermediate layer is applied cold to the brake disk, no mechanical stresses form between the brake disk and the intermediate layer, as is the case given a thermally applied coating. “Cold” is understood to mean an application of the intermediate layer at room temperature; the temperature can also lie slightly above room temperature up to approximately 50 degrees or 70 degrees Celsius, for example. However, it lies considerably below the temperature employed for thermal coating. Owing to its resilience, the intermediate layer reduces mechanical stresses between the surface coating and the brake disk, which reduces the risk of damage to the surface coating, for example as a result of cracking. Similarly, the intermediate layer can improve adhesion of the surface coating on the brake disk and/or can serve as a corrosion-resistant layer for the brake disk, which counteracts infiltration of corrosion in the surface coating.

The below description relates to advantageous configurations and developments of the disclosure.

The disclosure is intended in particular for brake disks made of gray cast iron, i.e. of cast iron.

Additional embodiments relate to a brake disk coated by the process according to the disclosure.

### BRIEF DESCRIPTION OF THE DRAWINGS

The disclosure will be explained in more detail hereinbelow with reference to an exemplary embodiment shown in the drawing, in which:

FIG. 1 shows an axial section of a brake disk according to the disclosure; and

FIG. 2 shows an enlarged detail II from FIG. 1.

The drawing is to be understood as a simplified and schematized illustration for understanding and for explaining the disclosure.

### DETAILED DESCRIPTION

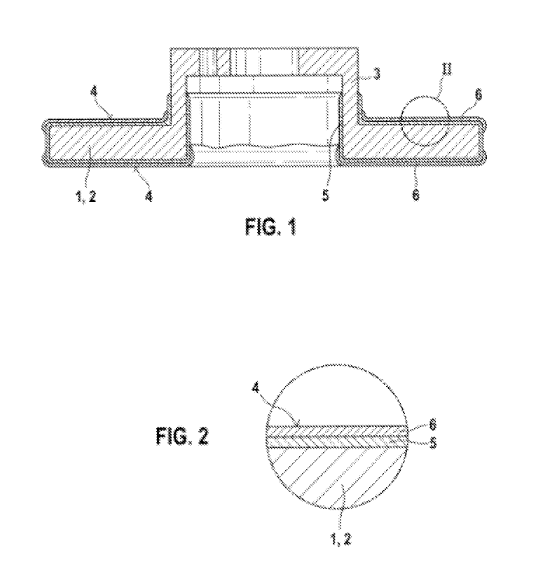

The brake disk 1 according to the disclosure shown in FIG. 1 has a brake ring 2 in the form of a perforated circle and a cup-shaped hub 3, which is concentric and integral with the brake ring 2. Faces of the brake ring 2 which are in the form of perforated circular disks form friction surfaces 4 of the brake disk 1, against which friction brake linings (not shown) of a disk brake (likewise not shown) are pressed during and for braking. The brake ring 2 can also be construed as the actual brake disk. The brake disk 1 consists of gray cast iron, i.e. of cast iron containing graphite flakes.

The brake disk 1 has an intermediate layer 5 applied cold. The intermediate layer 5 consists of a metal or a metal alloy; it comprises nickel, copper and/or chromium, for example. The intermediate layer 5 is deposited chemically or electrochemically, for example. The intermediate layer 5 covers the friction ring 2, i.e. the friction surfaces 4 and adjoining regions of the brake disk 1. It is necessary for the intermediate layer 5 to cover the friction surfaces 4, and it can also cover the brake disk 1 entirely.

A wear-reducing surface coating 6 is applied thermally to the intermediate layer 5. The surface coating 6 covers the friction surfaces 4 and, as a result of the application process, adjoining regions of the brake disk 1. It is necessary to cover the friction surfaces 4, and coverage of the brake disk 1 in its entirety is possible. The wear-reducing surface coating 6 is applied thermally, for example by flame spraying or arc spraying, i.e. at temperatures of between approximately 3000 and 4000 degrees Celsius. The surface coating 6 comprises carbides or carbide mixtures, in particular metal-like carbides, for example chromium carbide and/or tungsten carbide, which are incorporated in a matrix, in particular a metal matrix of, for example, nickel and/or cobalt, also a metal alloy.

In the drawing, layer thicknesses of the intermediate layer 5 and of the surface coating 6 are shown with an exaggerated thickness; the intermediate layer 5 and the surface coating 6 have layer thicknesses of several to several 10 micrometers, it being possible for the layer thicknesses of the intermediate layer 5 and of the surface coating 6 to be the same or different.

On account of the resilience of the intermediate layer 5, mechanical stresses between the surface coating 6 and the gray cast iron of the brake disk 1 are reduced. Such mechanical stresses form during cooling following the thermal application of the surface coating 6 and upon heating of the brake disk 1 during braking to temperatures of several 100 degrees Celsius, for example up to approximately 600 degrees Celsius. The surface coating 6 has a lower coefficient of thermal expansion than the brake disk 1, and therefore tensile stresses prevail in the surface coating 6 during cooling following the thermal application of the surface coating 6. As described, the tensile stresses are reduced by the intermediate layer 5 applied cold to the brake disk 1, which reduces the risk of damage to the surface coating 6, in particular as a result of cracking.

In addition, the intermediate layer 5 forms a corrosion-resistant layer, which counteracts infiltration of corrosion in the wear-reducing surface coating 6. In addition, the intermediate layer 5 forms a bonding layer; it improves adhesion of the wear-reducing surface coating 6 on the brake disk 1.

What is claimed is:

1. A process for coating a metal brake body having a friction region comprising:
applying an intermediate layer cold to the metal brake body; and
thermally applying a surface coating to the intermediate layer so as to form a friction surface.

2. The process according to claim 1, wherein the intermediate layer has a greater resilience than the metal brake body and the surface coating and/or the intermediate layer has a higher corrosion resistance than the metal brake body and/or the intermediate layer improves adhesion of the surface coating on the metal brake body.

3. The process according to claim 1, wherein applying the intermediate layer includes chemically or electrochemically depositing the intermediate layer on the metal brake body.

4. The process according to claim 1, wherein the intermediate layer comprises metal.

5. The process according to claim 1, wherein the metal brake body comprises gray cast iron.

6. A metal brake body having a friction region comprising:
a thermally applied surface coating which forms a friction surface; and
an intermediate layer applied cold between the metal brake body and the surface coating.
